(19) United States
(12) Patent Application Publication
(10) Pub. No.: US 2026/0211365 A1
(43) Pub. Date: Jul. 23, 2026

(54) IMAGE FORMING DEVICE AND PROGRAM

(71) Applicant: Kiyotaka Murakami, Sunto Shizuoka (JP)

(72) Inventor: Kiyotaka Murakami, Sunto Shizuoka (JP)

(73) Assignee: ETRIA CO., LTD., Kanagawa (JP)

(21) Appl. No.: 19/281,632

(22) Filed: Jul. 26, 2025

(30) Foreign Application Priority Data
Jan. 21, 2025 (JP) 2025-008154

(51) Int. Cl. G03G 15/00; G03G 21/16; G06K 7/10

(52) U.S. Cl. CPC G03G 15/703; G03G 15/6511; G03G 15/6552; G03G 15/6558; G03G 21/1657; G06K 7/10366; G03G 2215/00548; G03G 2215/00556; G03G 2215/00721

(57) ABSTRACT

There is provided an image forming device capable of more reliably detecting double feeding of print media. The image forming device has a housing unit, a conveyance unit, an image forming unit, and a control unit. The housing unit is configured to house print media to which wireless tags are attached. The conveyance unit is configured to convey the print media. The image forming unit is configured to form an image on the print media. The control unit is configured to perform a write process of writing tag information into the wireless tag. The control unit is configured to perform a first double feeding detecting process including a process of performing to read the tag information, then to perform one of a normal-time process and a double feeding-time process in accordance with whether or not two or more pieces of the tag information have been read.

### CROSS-REFERENCE TO RELATED APPLICATION

This application claims priority from Japanese Patent Application No. 2025-008154, filed Jan. 21, 2025, the contents of which are incorporated herein by reference in their entirety.

### FIELD

Embodiments described herein relate to an image forming device and a program.

Description of Related Art

### BACKGROUND

Conventionally, an image forming device capable of forming images on print media with Radio Frequency Identification (RFID) tags attached is known.

Here, in an image forming device as described in Patent Document 1, in a case in which print media with RFID tags attached are picked up by a pickup roller, double feeding occasionally occurs due to friction and static electricity between two or more sheet of the print media. Double feeding may not be detected as double feeding in a case in which the displacement in a conveyance direction between two or more sheet of the print media that are doubly fed is small. This is not desirable, as it leads to tag information being judged to have been successfully written to an RFID tag, even though the writing of the tag information to the RFID tag has failed.

### BRIEF DESCRIPTION OF THE DRAWINGS

FIG. 1 A diagram illustrating an example of the configuration of an image forming device 1.

FIG. 2 A diagram illustrating an example of the configuration of a rear face of one sheet of print media PP with a wireless tag TG.

FIG. 3 A diagram illustrating an example of the configuration of a front face of one sheet of print media PP with a wireless tag TG.

FIG. 4 A diagram illustrating an example of the functional configuration of a control unit 110.

FIG. 5 A diagram illustrating an example of an appearance in which one sheet of print media PP is picked up from a paper feed cassette 111 by a pickup roller 27.

FIG. 6 A diagram illustrating an example of changes in the received signal strength of tag information read from a wireless tag TG of one sheet of print media PP over time by conveying only one sheet of print media PP using the image forming device 1.

FIG. 7 A diagram illustrating an example of changes in the received signal strength of tag information read from wireless tags TG of two sheets of print media PP over time by conveying these two sheets of print media PP that are overlapped and bonded with no displacement in a conveyance direction using the image forming device 1.

FIG. 8 A diagram illustrating an example of changes in the received signal strength of tag information read from wireless tags TG of two sheets of print media PP over time by conveying these two sheets of print media PP that are overlapped and bonded with a displacement of 10 mm in the conveyance direction using the image forming device 1.

FIG. 9 A diagram illustrating an example of changes in received signal strength of tag information read from wireless tags TG of two sheets of print media PP over time by conveying these two sheets of print media PP that are overlapped and bonded with a displacement of 20 mm in the conveyance direction using the image forming device 1.

FIG. 10 A diagram for comparing average values of the received signal strengths described with reference to FIGS. 6 to 9.

FIG. 11 A diagram illustrating an example of the flow of a process in which the image forming device 1 performs a first double feeding detecting process.

### DETAILED DESCRIPTION

An image forming device according to an embodiment is described with reference to the drawings. In each drawing, the same reference signs are assigned to the same components. As an example of the image forming device according to the embodiment, an image forming device 1 is exemplarily described. An image forming device of an embodiment includes a housing unit, a conveyance unit, an image forming unit, and a control unit. The housing unit is configured to house print media to which wireless tags are attached. The conveyance unit is configured to convey the print media from the housing unit one by one. The image forming unit is configured to form an image on the print media conveyed by the conveyance unit. The control unit is configured to perform a write process of writing tag information into the wireless tag by controlling the conveyance unit and an antenna emitting radio waves to a conveyance path in which the print media is conveyed by the conveyance unit. The control unit performs a first double feeding detecting process including a process, of performing to read the tag information from the wireless tag by controlling the antenna, then to perform one of a normal-time process according to the conveyance of the print media using the conveyance unit being normal and a double feeding-time process according to the conveyance of the print media using the conveyance unit being double feeding in accordance with whether or not two or more pieces of the tag information have been read.

### Configuration of Image Forming Device

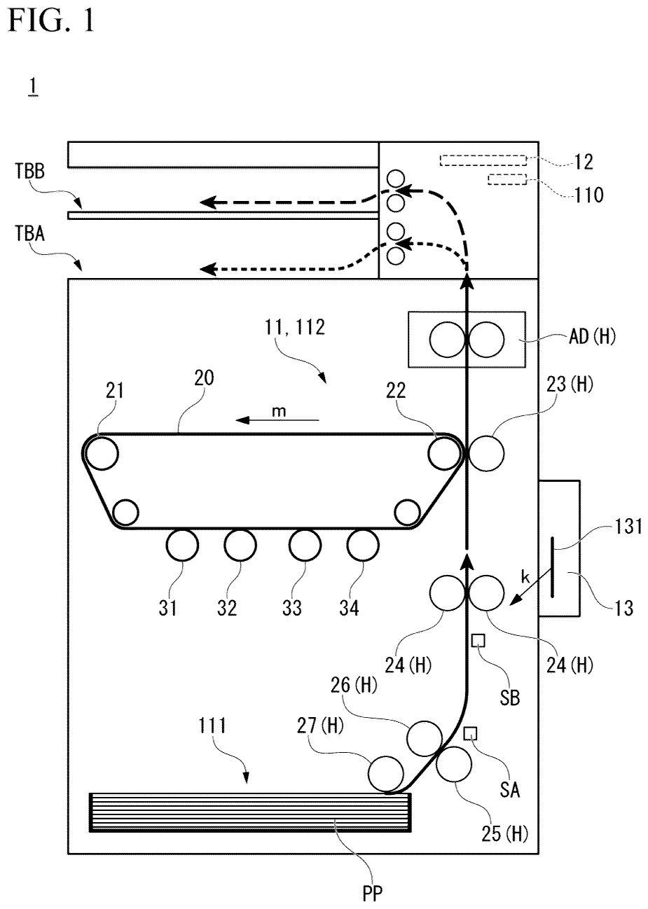

The configuration of the image forming device 1 is described with reference to FIG. 1. FIG. 1 is a diagram illustrating an example of the configuration of the image forming device 1.

The image forming device 1 is a device that forms images on print media PP. For example, the image forming device 1 is a multifunctional machine, a copier, a printer, or the like. The image forming device 1 may be any other device capable of forming images on the print media PP.

The print media PP is a media that is a target for which processing such as image formation and the like is performed by the image forming device 1. The print media PP may be any medium as long as it is media of sheet shape for which an image can be formed on at least one of a front face and a rear face. For example, the print media PP is printing sheets, a plastic films, or the like. A front face of the print media PP is a face that is determined in advance as a face on the front side out of two faces of the print media PP. A rear face of the print media PP is a face that is determined in advance as a face on the rear side out of the two faces of the print media PP.

Print media PP is classified into a type in accordance with the size of the print media PP, the thickness of the print media PP, the material of the print media PP, and the presence/absence of a wireless tag TG. The print media PP with a wireless tag TG is the print media PP to which a wireless tag TG is attached. The print media PP without a wireless tag TG is the print media PP to which no wireless tag TG is attached.

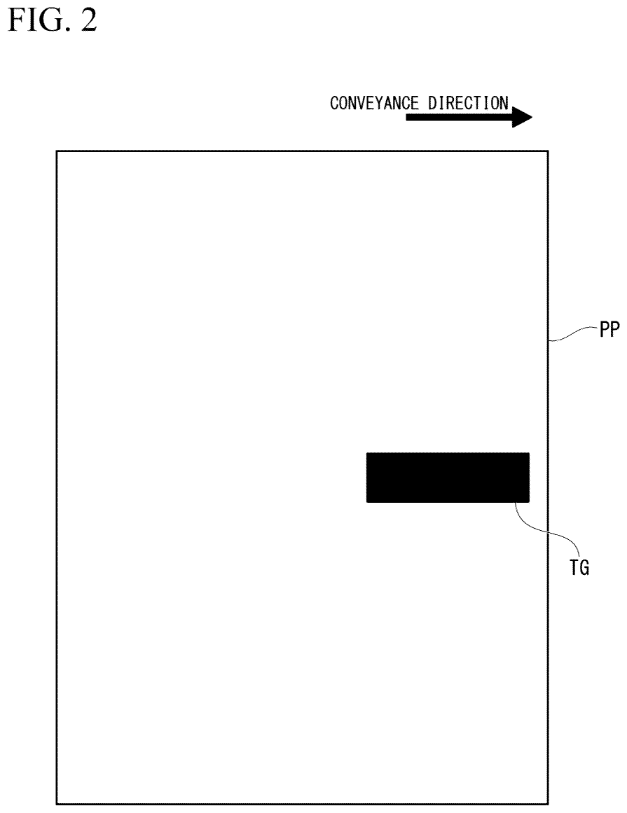

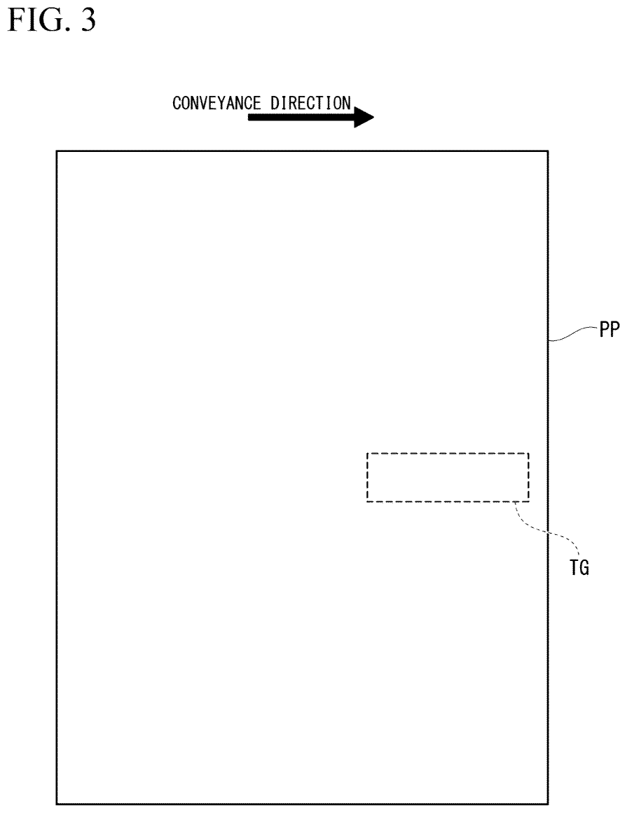

The wireless tag TG, for example, is a radio frequency identification (RFID) tag but is not limited thereto. FIG. 2 is a diagram illustrating an example of the configuration of the rear face of one sheet of print media PP with a wireless tag TG. FIG. 3 is a diagram illustrating an example of the configuration of the front face of one sheet of print media PP with a wireless tag TG. Arrows illustrated in FIGS. 2 and 3 represent a conveyance direction in which one sheet of print media PP is conveyed in the image forming device 1. The wireless tag TG has an IC (Integrated Circuit) chip and an antenna. The IC chip included in the wireless tag TG is an IC chip that writes/reads tag information. The antenna included in the wireless tag TG is an antenna that is connected to this IC chip and performs reception of the tag information written in this IC chip, transmission of the tag information read from this IC chip, and the like.

The image forming device 1 forms an image on print media PP of a type specified in advance in accordance with an operation received from a user. As an example, a case in which the image forming device 1 forms an image on the print media PP with a wireless tag TG is described. In this case, the image forming device 1 performs a write process of writing the tag information into the wireless tag TG of the print media PP. The write process is a process of writing the tag information into this wireless tag TG and performing verification of detecting whether or not this writing has been completed normally. The verification is performed by reading the tag information written in this wireless tag TG using the image forming device 1 and judging whether or not the read tag information coincides with the written tag information. In the verification, in a case in which it is judged that the read tag information coincides with the written tag information, the image forming device 1 detects that the writing has been completed normally. On the other hand, in the verification, in a case in which it is judged that the read tag information does not coincide with the written tag information, the image forming device 1 detects that the writing has not been completed normally. In the verification, in a case in which it is detected that the writing has not been completed normally, the image forming device 1 stores verification result information indicating that the writing has failed together with a time stamp representing the current date and time. After the verification result information is stored, the image forming device 1 notifies that the writing has failed. On the other hand, in the verification, in a case in which it is detected that the writing has been completed normally, the image forming device 1 stores verification result information indicating that this writing has been successful together with a time stamp representing the current date and time. After the verification result information is stored, the image forming device 1 forms an image on the print media PP to which a wireless tag TG, in which the tag information is written, is attached. After the image has been formed on the print media PP, the image forming device 1 heats the print media PP on which the image has been formed to fix the image to this print media PP. After the image has been fixed to this print media PP, the image forming device 1 outputs this print media PP to which the image has been fixed.

The image forming device 1, for example, includes a printer unit 11, a control panel 12, a wireless tag communication device 13, a output tray TBA, and a output tray TBB. The image forming device 1 may be configured to include other members such as an input tray, other devices, and the like in addition to the printer unit 11, the control panel 12, the wireless tag communication device 13, the output tray TBA, and the output tray TBB. The image forming device 1 may be configured not to include the wireless tag communication device 13. In this case, an externally-attached device corresponding to the wireless tag communication device 13 is attached to the image forming device 1 from the outside.

The printer unit 11 includes a control unit 110, a paper feed cassette 111, and an image forming unit 112.

The control unit 110 controls the entire image forming device 1. In other words, the control unit 110 controls the printer unit 11, the control panel 12, the wireless tag communication device 13, and the image forming unit 112. In FIG. 1, the control unit 110 is illustrated at a position different from an actual position for simplification of the drawing.

The paper feed cassette 111 houses print media PP of a type desired by a user. In this example, print media PP with wireless tags TG are housed in the paper feed cassette 111. The print media PP may be any print media PP as long as they are print media PP with wireless tags TG. The paper feed cassette 111 is an example of a housing unit.

The control panel 12 includes an operation receiving unit and a display unit. In FIG. 1, the control panel 12 is illustrated at a position different from an actual position for simplification of the drawing.

The operation receiving unit configured to receive an operation from a user. The operation receiving unit is an input device and, for example, is a touch pad, an input key, or the like. The operation receiving unit outputs information representing an operation received from a user to the control unit 110.

The display unit displays an image corresponding to an operation received through the operation receiving unit. The display unit is an image display device and, for example, is a liquid crystal display, an organic EL (Electroluminescence) display, or the like. The display unit may be configured integrally with the operation receiving unit as a touch panel.

The image forming unit 112 performs conveyance of print media PP and formation of an image represented by image data acquired from the control unit 110 on the print media PP in accordance with control from the control unit 110. Details of the configuration of the image forming unit 112 are described below.

The wireless tag communication device 13 includes an antenna 131 that emits radio waves to a predetermined emission area included in an area on a conveyance path through which print media PP passes in accordance with conveyance using the image forming unit 112. For example, the emission area is an area located upstream of two resist rollers 24 to be described below on the conveyance path in the area on the conveyance path but is not limited thereto.

The antenna 131 is, for example, an antenna that emits radio waves into an emission area. The antenna 131 may be configured using a single antenna or may be configured as an array antenna or the like using a plurality of antennas. An arrow k represented in FIG. 1 illustrates an example of a direction in which radio waves are emitted from the antenna 131.

The wireless tag communication device 13 causes the antenna 131 to emit radio waves corresponding to control from the control unit 110. In accordance with this, the wireless tag communication device 13 can write tag information into the wireless tag TG of print media PP that has the wireless tag TG. A method of writing the tag information into the wireless tag TG may be either a known method or a method to be developed in the future.

The output tray TBA is a tray to which print media PP conveyed by the image forming unit 112 is output. More specifically, the output tray TBA is a tray to which the print media PP conveyed by the image forming unit 112 is output in a normal-time process to be described below.

The output tray TBB is a tray to which print media PP conveyed by the image forming unit 112 is output. More specifically, the output tray TBB is a tray to which the print media PP conveyed by the image forming unit 112 is output in a double-feeding-time process to be described below.

### Configuration of Image Forming Unit

Hereinafter, the configuration of the image forming unit 112 is described below.

The image forming unit 112 includes at least an intermediate transfer belt 20, a driven roller 21, a backup roller 22, and a secondary transfer roller 23. The image forming unit 112 includes two resist rollers 24, a separation roller 25, a paper feed roller 26 that conveys print media PP together with the separation roller 25, and a pickup roller 27. The image forming unit 112 includes four sets of image forming stations including an image forming station 31, an image forming station 32, an image forming station 33, and an image forming station 34. The image forming unit 112 includes a fixing device AD. The image forming unit 112 includes a first detection unit SA and a second detection unit SB. The image forming unit 112 may be configured to include other rollers, other members such as a duplex printing device, other devices, and the like.

The intermediate transfer belt 20 is a belt onto which a toner image is primarily transferred by the four sets of image forming stations. The intermediate transfer belt 20 is supported by the driven roller 21, the backup roller 22, and the like. The intermediate transfer belt 20 rotates in a direction denoted by arrow m in FIG. 1. More specifically, the image forming unit 112 rotates the intermediate transfer belt 20 in this direction using a motor not illustrated in the drawing in accordance with control from the control unit 110.

The image forming station 31 is an image forming station for forming Y (yellow) images. The image forming station 32 is an image forming station for forming M (magenta) images. The image forming station 33 is an image forming station for forming C (cyan) images. The image forming station 34 is an image forming station for forming K (black) images. In the image forming unit 112, these four sets of image forming stations are disposed in a rotation direction of the intermediate transfer belt 20 below the intermediate transfer belt 20.

The image forming station 31 includes a photoconductor drum, a charging charger, an exposure scanning head, a developing device, a photoconductor cleaner, a primary transfer roller, and the like. In the image forming station 31, the charging charger, the exposure scanning head, the developing device, the photoconductor cleaner, and the primary transfer roller are disposed around the photoconductor drum 311. The primary transfer roller faces the photoconductor drum via the intermediate transfer belt 20.

The configuration of each of the image forming stations 32, 33, and 34 is similar to the configuration of such an image forming station 31. For this reason, hereinafter, description of the configuration of each of the image forming stations 32, 33, and 34 is omitted.

The secondary transfer roller 23 faces the backup roller 22 via the intermediate transfer belt 20. The secondary transfer roller 23 secondarily transfers a toner image, which has been primarily transferred onto the intermediate transfer belt 20, onto print media PP passing through the secondary transfer roller 23 and the intermediate transfer belt 20.

The two resist rollers 24 convey print media PP conveyed by each roller to a space between the secondary transfer roller 23 and the intermediate transfer belt 20. More specifically, the two resist rollers 24 convey the print media PP, which has been conveyed from the paper feed cassette 111 via the separation roller 25 and the paper feed roller 26, to a space between the secondary transfer roller 23 and the intermediate transfer belt 20.

The separation roller 25 separates print media PP picked up by the pickup roller 27, which picks up the print media PP from the paper feed cassette 111, one sheet at a time.

The paper feed roller 26, together with the separation roller 25, conveys print media PP to a space between the two resist rollers 24.

The pickup roller 27 picks up print media PP one sheet at a time from the paper feed cassette 111 and conveys the picked up print media PP to a space between the separation roller 25 and the paper feed roller 26.

The fixing device AD is a device that fixes a toner image on print media PP after the toner image is secondarily transferred by the secondary transfer roller 23. More specifically, the fixing device AD heats and pressurizes the print media PP while conveying the print media PP using rollers. In accordance with this, the fixing device AD fixes the toner image, which has been secondarily transferred onto the print media PP, to the print media PP. As a result, an image is formed on this print media PP.

The first detection unit SA detects print media PP located at a first position between the two resist rollers 24 and the paper feed roller 26 among positions on the conveyance path. The first position is a position that is closer to the paper feed roller 26 than the two resist rollers 24 between them. The position at which the first detection unit SA is located, which is illustrated in FIG. 1 is an example of the first position. The first detection unit SA is, for example, an optical sensor but is not limited thereto.

The second detection unit SB detects print media PP located at a second position, which is located downstream of the first position on the conveyance path between the two resist rollers 24 and the paper feed roller 26, among positions on the conveyance path. The second position is a position closer to the two resist rollers 24 than the paper feed roller 26 between them. The position where the second detection unit SB is located, which is illustrated in FIG. 1, is an example of a second position. The second detection unit SB is, for example, an optical sensor but is not limited thereto.

### Operation of Image Forming Unit

Hereinafter, the operation of the image forming unit 112 is described below.

First, the operation of the four sets of image forming stations is described using the operation of the image forming station 31 as an example.

After charging the photoconductor drum using the charging charger, the image forming station 31 performs exposing using the exposure scanning head. In accordance with this, the image forming station 31 forms an electrostatic latent image on the photoconductor drum. Thereafter, the image forming station 31 causing a developing device to develop the electrostatic latent image formed on the photoconductor drum. The developing device develops an electrostatic latent image formed on the photoconductor drum as a toner image using a two-component developer formed using toner and carrier. The primary transfer roller primarily transfers a toner image formed on the photoconductor drum in this way onto the intermediate transfer belt 20. After this primary transfer is performed, the photoconductor cleaner removes residual toner from the photoconductor drum.

Each of the image forming stations 31, 32, 33, and 34 forms a color toner image on the intermediate transfer belt 20 using the primary transfer roller. The color toner image is formed by sequentially overlapping toner images of Y (yellow), M (magenta), C (cyan), and K (black).

Next, the operation of the secondary transfer roller 23 is described. The secondary transfer roller 23 secondarily transfers a color toner image formed on the intermediate transfer belt 20 altogether onto print media PP passing between the secondary transfer roller 23 and the intermediate transfer belt 20.

Next, an operation of conveying print media PP, among operations of the image forming unit 112 is described.

Print media PP conveyed from the paper feed cassette 111 is bent into a nip of the two resist rollers 24. In accordance with this, the location of a tip end of the print media PP is aligned. The tip end of a certain print media PP is an end out of ends of this print media PP in a direction in which this print media PP is conveyed. After the position of the tip end of this print media PP is aligned, the two resist rollers 24 convey this print media PP to a space between the secondary transfer roller 23 and the intermediate transfer belt 20 in accordance with a timing at which the image forming unit 112 transfers a toner image onto this print media PP.

Inside the image forming unit 112, print media PP is conveyed along a conveyance path determined in advance by the two resist rollers 24 and the fixing device AD.

The two resist rollers 24 start rotating in alignment with the position of the toner image on the rotating intermediate transfer belt 20 and move print media PP to the position of the secondary transfer roller 23. In accordance with this, the toner image formed on the intermediate transfer belt 20 is secondarily transferred to the print media PP by the secondary transfer roller 23. After the toner image is secondarily transferred to the print media PP, the secondary transfer roller 23 conveys the print media PP to the fixing device AD along a conveyance path determined in advance. The fixing device AD fixes the toner image that has been secondarily transferred to the print media PP conveyed from the secondary transfer roller 23 to this print media PP while conveying the print media PP. In accordance with this, the toner image that has been secondarily transferred is formed as an image in this print media PP. The print media PP after the image having been formed thereon by the fixing device AD is output to the output tray TBA by a roller not illustrated in the drawing. On the other hand, the print media PP, which has been conveyed from the secondary transfer roller 23 to the fixing device AD along the conveyance path without transferring the toner image, is output to the output tray TBB by a roller not illustrated in the drawing. A method of switching the output destination of the print media PP between the output tray TBA and the output tray TBB may be a known method or a method to be developed in the future.

In this way, the secondary transfer roller 23, the two resist rollers 24, the separation roller 25, the paper feed roller 26, the pickup roller 27, and the fixing device AD constitute a conveyance unit H that conveys print media in the image forming device 1. The conveyance unit H may be configured to include other rollers.

### Functional Configuration of Control Unit

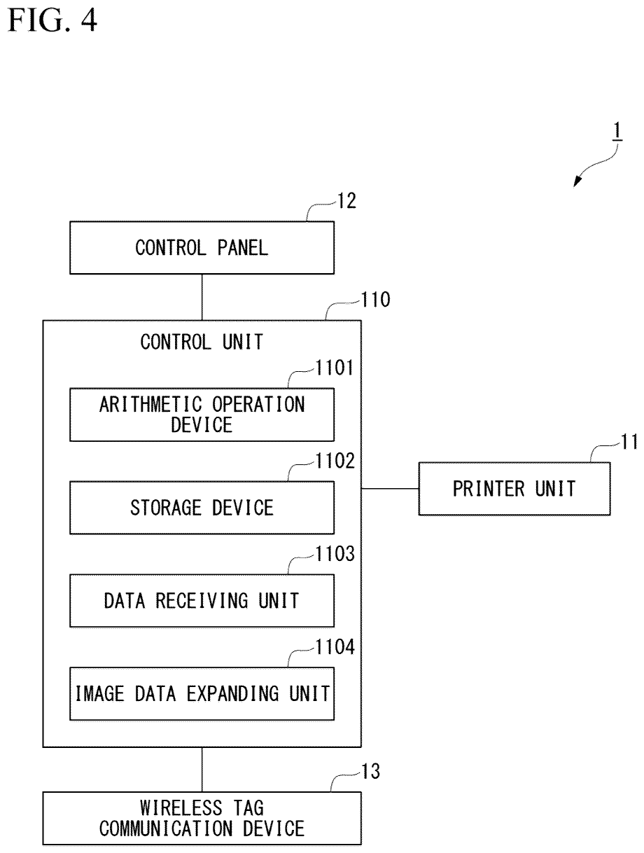

Next, the functional configuration of the control unit 110 is described with reference to FIG. 4. FIG. 4 is a diagram illustrating an example of the functional configuration of the control unit 110.

As illustrated in FIG. 4, the control unit 110 is connected to the printer unit 11, the control panel 12, and the wireless tag communication device 13 to be able to communicated therewith. The control unit 110 includes an arithmetic operation device 1101, a storage device 1102, a data receiving unit 1103, and an image data expanding unit 1104.

The arithmetic operation device 1101 is, for example, a CPU (Central Processing Unit), an ASIC (Application Specific Integrated Circuit), or the like. The arithmetic operation device 1101 controls each of the printer unit 11, the control panel 12, and the wireless tag communication device 13 in accordance with various programs stored in the storage device 1102.

The storage device 1102 is a ROM (Read Only Memory), a RAM (Random Access Memory), a HDD (Hard Disk Drive), a SSD (Solid State Drive), or the like. The storage device 1102 may be separate from the control unit 110.

The data receiving unit 1103 receives print data (for example, data described in a page description language or the like) representing an image to be printed from a host such as a PC (Personal Computer) and stores the received print data in the storage device 1102.

The image data expanding unit 1104 expands the print data stored in the storage device 1102 by the data receiving unit 1103 into data that can be printed by the printer unit 11 (for example, raster data or the like) by determining printing conditions or the like and stores the data in the storage device 1102.

In the image forming device 1 having the configuration described above, in a case in which print media PP is picked up by the pickup roller 27, double feeding may occur due to friction and static electricity between two or more sheets of the print media PP. Then, in a case in which displacement in the conveyance direction between two or more sheets of the print media that have been doubly fed is small, the double feeding may not be detected as double feeding. This leads to tag information being judged to have been successfully written into the wireless tag TG, even though the writing of the tag information into the wireless tag TG has failed, which is not desirable.

Thus, the image forming device 1 performs a first double feeding detecting process. The first double feeding detecting process is a process that includes a process of reading tag information from the wireless tag TG of print media PP and performing any one of a normal-time process and a double-feeding-time process in accordance with whether or not there are two or more pieces of the tag information that have been read. The normal-time process is a process corresponding to the conveyance of the print media PP, which is performed by a conveyance unit H, being normal. Details of the normal-time process are described below. The double-feeding-time process is a process corresponding to the conveyance of the print media PP, which is performed by the conveyance unit H, being double feeding. Details of the double-feeding-time process is described below. By performing the first double feeding detecting process, the image forming device 1 can more reliably detect double feeding of the print media PP with a wireless tag TG. For convenience of explanation, displacement in the conveyance direction between two or more sheets of the print media PP is referred to as displacement between two or more sheets of the print media PP.

As an example, a case in which the image forming device 1 performs a second double feeding detecting process together with the first double feeding detecting process is described. The second double feeding detecting process is a process of detecting whether or not double feeding has occurred based on a detection result acquired by the first detection unit SA and a detection result acquired by the second detection unit SB after the image forming unit 112 starts conveying print media PP. In other words, the second double feeding detecting process is a process of detecting that double feeding has occurred by detecting displacement in a case in which two or more sheets of the print media PP overlap each other, and the displacement between the two or more sheets of the print media PP is a predetermined length or more. To rephrase it further, the second double feeding detecting process is a process of detecting that double feeding has occurred by detecting displacement in a case in which two or more sheets of the print media PP overlap each other, and the displacement between the two or more sheets of the print media PP is larger. The predetermined length is, for example, 20 mm but may be shorter or longer than 20 mm. On the other hand, in other words, the first double feeding detecting process is a process of detecting that double feeding has occurred in a case in which two or more sheets of the print media PP overlap each other, and displacement between the two or more sheets of the print media PP is less than a predetermined length. To rephrase it further, the first double feeding detecting process is a process of detecting that double feeding has occurred in a case in which two or more sheets of the print media PP overlap each other, and displacement between the two or more sheets of the print media PP is small. The image forming device 1 performs the second double feeding detecting process after the image forming unit 112 starts conveying the print media PP and, in a case in which it is judged that double feeding has not occurred by the second double feeding detecting process, performs the first double feeding detecting process. In accordance with this, the image forming device 1 can suppress omissions of detection of double feeding in accordance with the magnitude of displacement of two or more sheets of the print media PP overlapping each other in the conveyance direction.

### Details of First Double Feeding Detecting Process and Second Double Feeding Detecting Process

Details of the first double feeding detecting process and the second double feeding detecting process are described below.

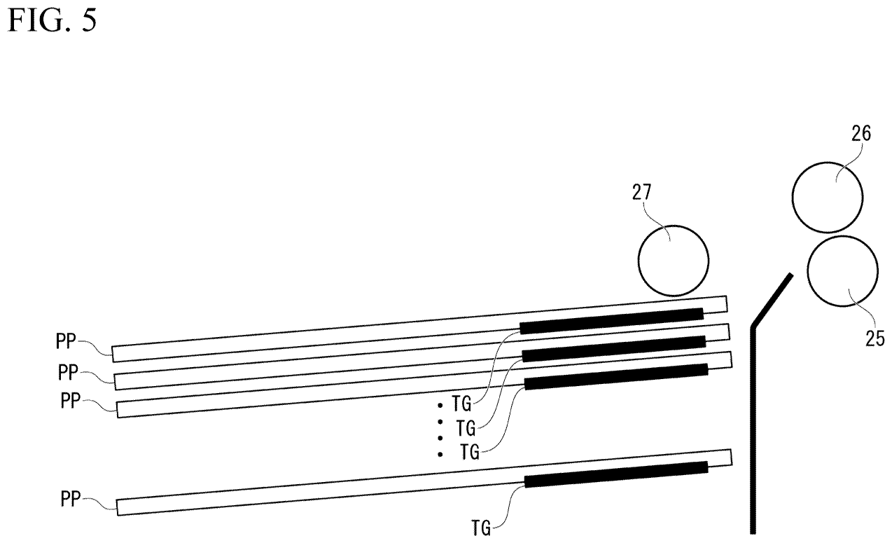

FIG. 5 is a diagram illustrating an example of an appearance in which one sheet of print media PP is picked up from the paper feed cassette 111 by the pickup roller 27. As illustrated in FIG. 5, inside the paper feed cassette 111, the print media PP of an uppermost stage is picked up by the pickup roller 27. At this time, two or more sheets of the print media PP may be picked up by the pickup roller 27 with overlapping each other due to friction, static electricity, or the like. In the image forming device 1, even in a case in which two or more sheets of the print media PP are picked up by the pickup roller 27, the print media PP are separated one by one by the separation roller 25. However, two or more sheets of the print media PP picked up by the pickup roller 27 with overlapping each other may not be separated one by one by the separation roller 25. In such a case, the separation roller 25 and the paper feed roller 26 convey two or more sheets of the print media PP in an overlapping state to the two resist rollers 24.

In a case in which displacement between two or more sheets of the print media PP in an overlapping state is a predetermined length or more, the image forming device 1 can detect the overlapping of these two or more sheets of the print media PP using the first detection unit SA and the second detection unit SB. For example, in a case in which the print media PP has been detected by both the first detection unit SA and the second detection unit SB, the image forming device 1 can judge that two or more sheets of the print media PP are overlapping each other. The image forming device 1 may be configured to detect whether or not double feeding has occurred based on detection results acquired by the first detection unit SA and the second detection unit SB by using another method. In this way, the process of detecting whether or not double feeding has occurred based on detection results acquired by the first detection unit SA and the second detection unit SB is the second double feeding detecting process described above.

On the other hand, in a case in which displacement between two or more sheets of the print media PP in an overlapping state is less than a predetermined length, the image forming device 1 cannot detect that these two or more sheets of the print media PP are overlapping each other using the first detection unit SA and the second detection unit SB. For this reason, in a case in which it is judged that no double feeding has occurred in the second double feeding detecting process, the image forming device 1 performs the first double feeding detecting process. In the first double feeding detecting process, the image forming device 1 performs at least processes described below.

The image forming device 1 stops conveyance of print media PP such that the print media PP is located inside an emission area by controlling the paper feed roller 26 and the separation roller 25. The image forming device 1 reads tag information from the wireless tag TG of the print media PP located inside the emission area by controlling the antenna 131. Although the tag information to be read by the image forming device 1 is, for example, the tag information that is written into this wireless tag TG at the time of shipment of the print media PP, it is not limited to this and may be the tag information written into the wireless tag TG by the image forming device 1. Although the tag information written in a wireless tag TG at the time of shipment of the print media PP is, for example, an Electronic Product Code (EPC), it is not limited thereto. After reading the tag information using the antenna 131, the image forming device 1 judges whether or not two or more pieces of the tag information have been read. In a case in which it is judged that one piece of the tag information has been read, the image forming device 1 judges that no double feeding has occurred. On the other hand, in a case in which it is judged that two or more pieces of the tag information have been read, the image forming device 1 judges whether or not double feeding has occurred based on a difference between received signal strengths of the two or more pieces of the tag information. Although the received signal strength is a RSSI (Received Signal Strength Indication), it is not limited thereto but may be another value that indicates the strength of a received signal.

The reason why it is possible to judge whether or not double feeding has occurred based on a difference between received signal strengths is that a difference between received signal strengths tends to be small in a case in which double feeding has occurred, and a difference between received signal strengths tends to be large in a case in which no double feeding has occurred.

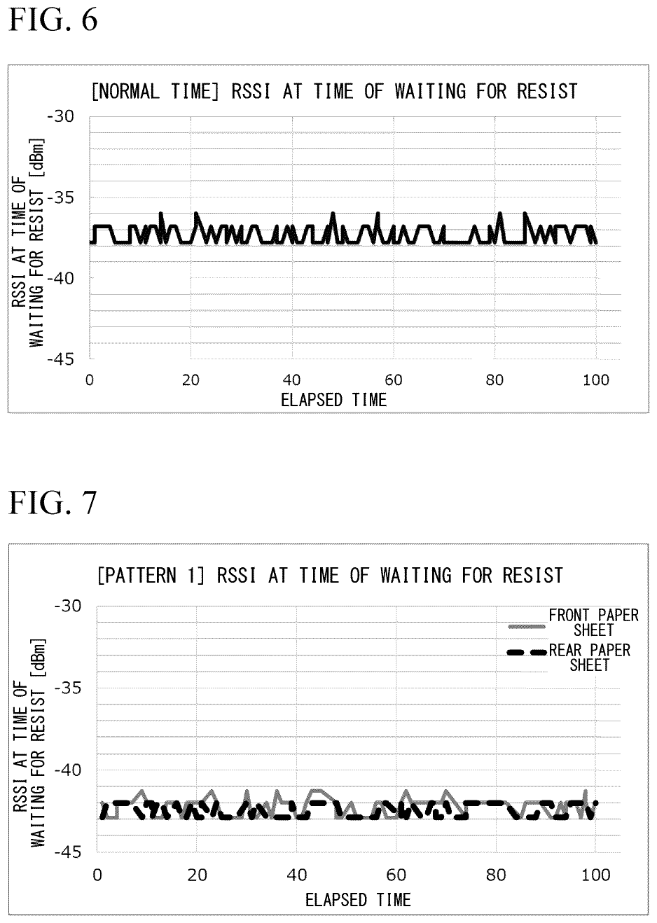

FIG. 6 is a diagram illustrating an example of changes in the received signal strength of tag information read from a wireless tag TG of one sheet of print media PP over time by conveying only one sheet of the print media PP using the image forming device 1. A horizontal axis of a graph illustrated in FIG. 6 represents an elapsed time after starting to read the tag information from the wireless tag TG. On the other hand, a vertical axis of this graph represents a received signal strength of the tag information read from the wireless tag TG. A solid broken line plotted in this graph represents an example of changes in the received signal strength of the tag information, which has been read from the wireless tag TG in the image forming device 1, over time. In the example illustrated in FIG. 6, the image forming device 1 reads only one piece of the tag information. The reason for this is that only one sheet of the print media PP is conveyed by the image forming device 1. In this example, an average value of received signal strengths of the tag information read by the image forming device 1 is about 37 dBm.

On the other hand, FIG. 7 is a diagram is a diagram illustrating an example of changes in the received signal strength of tag information read from wireless tags TG of two sheets of print media PP over time by conveying these two sheets of the print media PP that are overlapped and bonded with no displacement in a conveyance direction using the image forming device 1. A horizontal axis of a graph illustrated in FIG. 7 represents an elapsed time after starting to read the tag information from the wireless tag TG. On the other hand, a vertical axis of this graph represents a received signal strength of the tag information read from the wireless tag TG. In the example illustrated in FIG. 7, the image forming device 1 reads two pieces of the tag information. The reason for this is that two sheets of the print media PP are overlapping each other. A solid broken line plotted in this graph illustrates an example of changes in the received signal strength of the tag information, which has been read from a wireless tag TG of a front paper sheet, over time with one of two sheets of the print media PP overlapping each other set as the front paper sheet. A dotted broken line plotted in this graph illustrates an example of changes in the received signal strength of the tag information, which has been read from a wireless tag TG of a rear paper sheet, over time with the other of the two sheets of the print media PP overlapping each other set as the rear paper sheet. Since there is no displacement between two sheets of the print media PP, which have been conveyed by the image forming device 1, in the conveyance direction, average values of received signal strengths of the tag information read from the wireless tags TG of the front paper sheet and the rear paper sheet are almost the same. The average value of received signal strengths of the tag information read from the wireless tags TG of the front paper sheet is about 42.4 dBm. The average value of received signal strengths of the tag information read from the wireless tags TG of the rear paper sheet is about 42.5 dBm. In this way, in a case in which there is no displacement between two sheets of the print media PP in the conveyance direction, a difference between received signal strengths of two pieces of the tag information read from the wireless tags TG of the two sheets of the print media PP is almost zero.

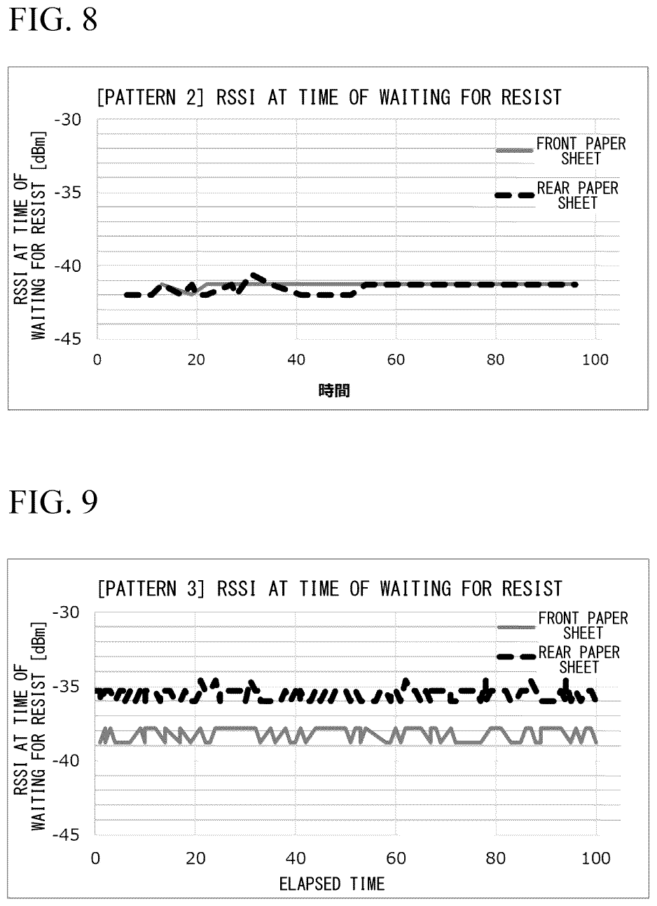

FIG. 8 is a diagram illustrating an example of changes in the received signal strength of tag information read from wireless tags TG of two sheets of print media PP over time by conveying these two sheets of the print media PP that are overlapped and bonded with a displacement of 10 mm in the conveyance direction using the image forming device 1. A horizontal axis of a graph illustrated in FIG. 8 represents an elapsed time after starting to read the tag information from the wireless tag TG. On the other hand, a vertical axis of this graph represents a received signal strength of the tag information read from the wireless tag TG. Also in the example illustrated in FIG. 8, the image forming device 1 reads two pieces of the tag information. The reason for this is that two sheets of the print media PP are overlapping each other. A solid broken line plotted in this graph illustrates an example of changes in the received signal strength of the tag information, which has been read from a wireless tag TG of a front paper sheet, over time with the print media PP on the downstream side of the conveyance path out of two sheets of the print media PP overlapping each other set as the front paper sheet. A dotted broken line plotted in this graph illustrates an example of changes in the received signal strength of the tag information, which has been read from a wireless tag TG of a rear paper sheet, over time with the print media PP on the upstream side of the conveyance path out of two sheets of the print media PP overlapping each other set as the rear paper sheet. Even in a case in which one of the two sheets of the print media PP is displaced by 10 mm in the conveyance direction from the other thereof, an average value of received signal strengths of the tag information read from the wireless tag TG of the front paper sheet is about 38 dBm. On the other hand, an average value of received signal strengths of the tag information read from the wireless tag TG of the rear paper sheet is about 36 dBm. In this way, in a case in which a displacement between two sheets of the print media PP in the conveyance direction is 10 mm, a difference between received signal strengths of two pieces of the tag information read from the wireless tags TG of the two sheets of the print media PP is about 2 dBm.

FIG. 9 is a diagram illustrating an example of changes in received signal strength of tag information read from wireless tags TG of two sheets of the print media PP over time by conveying these two sheets of the print media PP that are overlapped and bonded with a displacement of 20 mm in the conveyance direction using the image forming device 1. A horizontal axis of a graph illustrated in FIG. 9 represents an elapsed time after starting to read the tag information from the wireless tag TG. On the other hand, a vertical axis of this graph represents a received signal strength of the tag information read from the wireless tag TG. Also in the example illustrated in FIG. 9, the image forming device 1 reads two pieces of the tag information. The reason for this is that two sheets of the print media PP are overlapping each other. A solid broken line plotted in this graph illustrates an example of changes in the received signal strength of the tag information, which has been read from a wireless tag TG of a front paper sheet, over time with the print media PP on the downstream side of the conveyance path out of two sheets of the print media PP overlapping each other set as the front paper sheet. A dotted broken line plotted in this graph illustrates an example of changes in the received signal strength of the tag information, which has been read from a wireless tag TG of a rear paper sheet, over time with the print media PP on the upstream side of the conveyance path out of two sheets of the print media PP overlapping each other set as the rear paper sheet. Since one of the two sheets of the print media PP is displaced by 20 mm in the conveyance direction from the other thereof, an average value of received signal strengths of the tag information read from the wireless tag TG of the front paper sheet is about 38 dBm. On the other hand, also in this case, an average value of received signal strengths of the tag information read from the wireless tag TG of the rear paper sheet is about 36 dBm. In this way, also in a case in which a displacement between two sheets of the print media PP in the conveyance direction is 20 mm, a difference between received signal strengths of two pieces of the tag information read from the wireless tags TG of the two sheets of the print media PP is about 2 dBm.

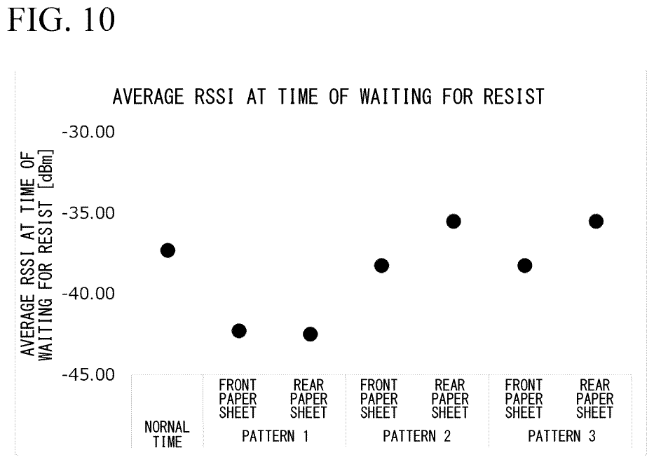

FIG. 10 is a diagram for comparing average values of the received signal strengths described with reference to FIGS. 6 to 9. As illustrated in FIG. 10, in a case in which two sheets of print media PP are overlapping each other, a difference between received signal strengths of tag information read from wireless tags TG of the two sheets of the print media PP overlapping each other is about several dBm. On the other hand, although description using illustration is omitted, for example, a difference between the received signal strength of the tag information read from the wireless tag TG of the print media PP located on the conveyance path and the received signal strength of the tag information read from the wireless tag TG of the print media PP located inside the paper feed cassette 111 is several tens of dBm or more. In other words, a difference between received signal strengths of the tag information read from the wireless tags TG of two sheets of the print media PP not overlapping each other is several tens of dBm or more. Thus, in a case in which it is judged that there are two or more pieces of the tag information read from the print media PP located within the emission area, the image forming device 1 judges whether or not a difference between reception signal strengths of those two or more pieces of the tag information is included within a predetermined range. Although the predetermined range, for example, is 10 dBm, it may be either a range narrower than 10 dBm or a range wider than 10 dBm. The narrower the predetermined range, it can be more suppressed that occurrence of double feeding is judged although double feeding is not occurring, and the wider the predetermined range, it can be more suppressed that no occurrence of double feeding is judged although double feeding is occurring. For example, in the example illustrated in FIG. 10, in a case in which the predetermined range is about 5 dBm, compared to a case in which the predetermined range is about 10 dBm, it can be more reliably suppressed to judge occurrence of double feeding although no double feeding is occurring without reducing the detection accuracy for the occurrence of double feeding. The predetermined range is determined such that the detection accuracy for the occurrence of double feeding is a desired accuracy through simulations, experiments, and the like performed in advance. When a difference between reception signal strengths of read the tag information is a value included within the predetermined range, the image forming device 1 performs a double feeding-time process. On the other hand, when a difference between reception signal strengths of read the tag information is a value outside the predetermined range, the image forming device 1 performs a normal-time process.

The image forming device 1 performs a process including the process as described above as a first double feeding detecting process. In a case in which print media PP is located with the emission area, the image forming device 1 may perform such a first double feeding detecting process either before the write process described above or after the write process. As an example, a case in which, in a case in which the print media PP is located within the emission area, the image forming device 1 performs the first double feeding detecting process before a write process is described.

### Details of Double Feeding-Time Process and Normal-Time Process

Details of the double feeding-time process and the normal-time process are described.

The double feeding-time process is a process including a process of resuming conveyance of print media PP by controlling the conveyance unit H and outputting the print media PP to the output tray TBB without forming an image on the print media PP using the image forming unit 112. In other words, in a case in which it is judged that double feeding has occurred, the image forming device 1 does not perform a write process and formation of an image for two or more sheets of the print media PP that are in an overlapping state and outputs these two or more sheets of the print media PP to the output tray TBB. In accordance with this, the image forming device 1 can suppress the print media PP that have been doubly fed from being discarded. This leads to suppression of an increase in financial cost, suppression of an increase in the environmental load, and the like, which are useful.

On the other hand, the normal-time process is a process including a process of resuming conveyance of print media PP by controlling the conveyance unit H and forming an image on the print media PP using the image forming unit 112, and then outputting the print media PP to the output tray TBA. In other words, in a case in which it is judged that double feeding has not occurred, the image forming device 1 performs a write process and formation of an image for the print media PP and outputs the print media PP to the output tray TBA. In accordance with this, the image forming device 1 can output the print media PP for which the write process and the formation of an image have been normally performed to a output destination different from a output destination of the print media PP that have been doubly fed. This leads to suppression of the print media PP, for which the write process and the formation of an image have been normally performed, from being erroneously discarded, which are useful.

### Process in Which Image Forming Device Performs First Double Feeding Detecting Process

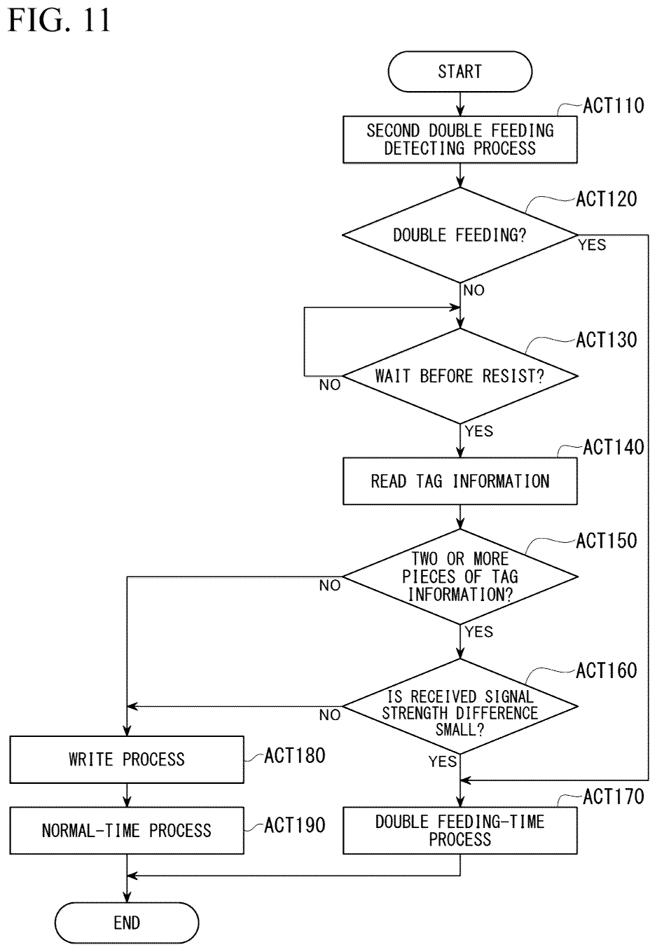

A process in which the image forming device 1 performs the first double feeding detecting process is described with reference to FIG. 11. FIG. 11 is a diagram illustrating an example of the flow of a process in which the image forming device 1 performs the first double feeding detecting process. As an example, a case in which a process accompanying feeding of print media PP using the conveyance unit H has started at a timing before the process ACT110 illustrated in FIG. 11 is described. Although this process, for example, is a process of forming an image on the print media PP and the like, it is not limited thereto.

After the process accompanying conveyance of print media PP according to the conveyance unit H starts, the control unit 110 performs the second double feeding detecting process (ACT110). In other words, in ACT110, in accordance with the second double feeding detecting process, the control unit 110 judges whether or not double feeding is occurring based on detection results acquired by the first detection unit SA and the second detection unit SB.

Next, the control unit 110 judges whether or not it has been judged that double feeding is occurring in accordance with the second double feeding detecting process executed in ACT110 (ACT120). In other words, the control unit 110 judges whether or not double feeding has been detected in accordance with this second double feeding detecting process in ACT120. In FIG. 11, the process of ACT120 is represented using “DOUBLE FEEDING?”.

In a case in which it is judged that double feeding is occurring in accordance with the second double feeding detecting process executed in ACT110 (ACT120—Yes), the control unit 110 performs the double feeding-time process described above (ACT170). In accordance with this, the control unit 110 can output two or more sheets of print media PP that have been doubly fed to the output tray TBB. After the process of ACT170, the control unit 110 ends the process of the flowchart illustrated in FIG. 11.

On the other hand, in a case in which it is judged that double feeding has not occurred in accordance with the second double feeding detecting process executed in ACT110 (ACT120—No), the control unit 110 waits until print media PP that has been conveyed by the paper feed roller 26 and the separation roller 25 stops within the emission area (ACT130). In this example, the emission area is located upstream of two resist rollers 24 in the conveyance path. For this reason, in FIG. 11, the process of ACT130 is represented using “WAIT BEFORE RESIST?”. A method in which the control unit 110 performs judgment of ACT130 may be a known method or a method that will be developed in the future.

In a case in which it is judged that print media PP that has been conveyed by the paper feed roller 26 and the separation roller 25 has stopped within the emission area (ACT130—Yes), the control unit 110 reads tag information from a wireless tag TG of the print media PP that is stopping within the emission area by controlling the antenna 131 (ACT140).

The control unit 110 judges whether or not two or more pieces of tag information have been read in ACT140 (ACT150).

In a case in which it is judged that one piece of tag information has been read in ACT140 (ACT150—No), the control unit 110 performs a write process for the wireless tag TG of print media PP that is stopping within the emission area by controlling the antenna 131 (ACT180).

Next, the control unit 110 performs the normal-time process described above (ACT190). In accordance with this, the control unit 110 can form an image on print media PP for which the write process has been performed in ACT180 and output print media PP after formation of the image to the output tray TBA. After the process of ACT190, the control unit 110 ends the process of the flowchart illustrated in FIG. 11.

On the other hand, in a case in which it is judged that two or more pieces of tag information have been read in ACT140 (ACT150—Yes), the control unit 110 judges whether or not a difference between received signal strengths of these two or more pieces of the tag information is a value within a predetermined range (ACT160). In FIG. 11, the process of ACT160 is represented using “IS RECEIVED SIGNAL STRENGTH DIFFERENCE SMALL?”.

In a case in which it is judged that a difference between received signal strengths of two or more pieces of tag information read in ACT140 is a value outside a predetermined range (ACT160—No), the control unit 110 causes the process to proceed to ACT180 and performs a write process for the wireless tag TG of print media PP that is stopping within the emission area by controlling the antenna 131.

On the other hand, in a case in which it is judged that a difference between received signal strengths of two or more pieces of tag information read in ACT140 is a value within the predetermined range (ACT160—Yes), the control unit 110 causes the process to proceed to ACT170 and performs the double feeding-time process.

As above, the image forming device 1 reads tag information from wireless tags TG by controlling the antenna 131 and, in accordance with whether or not the number of pieces of the tag information that have been read is two or more, performs the first double feeding detecting process including a process performing one of the normal-time process according to the conveyance of print media PP using the conveyance unit H being normal and the double feeding-time process according to the conveyance of print media using the conveyance unit H being double feeding. In accordance with this, the image forming device 1 can more reliably detect double feeding of the print media PP to which wireless tags TG are attached.

### Modified Example of Embodiment

In the process of the flowchart illustrated in FIG. 11, the image forming device 1 may have a configuration in which the process of ACT160 is omitted. In such a case, in the first double feeding detecting process, the image forming device 1 performs the normal-time process in a case in which one piece of tag information has been read and performs the double feeding-time process in a case in which two or more pieces of the tag information have been read. Also in this way, the image forming device 1 can more reliably detect double feeding of print media PP to which wireless tags TG are attached.

The image forming device 1 may be configured to accept an operation of designating whether or not the process of ACT160 is performed in the process of the flowchart illustrated in FIG. 11.

The image forming device 1 may have a configuration in which the processes of ACT110 and ACT120 are omitted in the process of the flowchart illustrated in FIG. 11. In other words, the image forming device 1 may be configured not to perform the second double feeding detecting process.

The image forming device 1 may be configured to accept an operation of designating whether or not the processes of ACT110 and ACT120 are performed in the process of the flowchart illustrated in FIG. 11.

The image forming device 1 may be configured to perform the process of ACT180 between the process of ACT130 and the process of ACT140 illustrated in FIG. 11. In other words, the image forming device 1 may be configured to perform a write process before the first double feeding detecting process.

The image forming device 1 may be configured to perform writing of tag information in the write process and perform verification in the write process in ACT180 between the process of ACT130 and the process of ACT140 illustrated in FIG. 11.

The image forming device 1 may be configured to display information indicating occurrence of double feeding on a display unit of the control panel 12 in the process of ACT170 illustrated in FIG. 11.

The image forming device 1 may be configured to include a speaker and output a sound indicating occurrence of double feeding to the speaker in the process of ACT170 illustrated in FIG. 11.

The second double feeding detecting process may be a process including a process of detecting double feeding of two or more sheets of print media PP overlapping each other with deviating by a predetermined length or more in the conveyance direction using another method in place of the process of judging whether or not double feeding is occurring based on detection results acquired by the first detection unit SA and the second detection unit SB.

The pickup roller 27 may be configured to be included in a paper feed cassette 111 instead of the configuration being included in the image forming unit 112.

The items described above may be combined in any way.

### Supplementary Note

[1]

An image forming device including: a housing unit configured to house print media to which wireless tags are attached; a conveyance unit configured to convey the print media from the housing unit one by one; an image forming unit configured to form an image on the print media conveyed by the conveyance unit; and a control unit configured to perform a write process of writing tag information into the wireless tag by controlling the conveyance unit and an antenna emitting radio waves to a conveyance path in which the print media is conveyed by the conveyance unit, in which the control unit performs a first double feeding detecting process including a process, of performing to read the tag information from the wireless tag by controlling the antenna, then to perform one of a normal-time process according to the conveyance of the print media using the conveyance unit being normal and a double feeding-time process according to the conveyance of the print media using the conveyance unit being double feeding in accordance with whether or not two or more pieces of the tag information have been read.

[2]

The image forming device described in [1], in which, in a case in which two or more pieces of the tag information have been read in the first double feeding detecting process, the control unit performs the double feeding-time process when a difference between received signal strengths of the two or more pieces of the tag information is a first value within a predetermined range and performs the normal-time process when the difference is a second value outside the predetermined range.

[3]

The image forming device described in [1] or [2], a first output tray to which the print media conveyed by the conveyance unit is output; and a second output tray to which the print media conveyed by the conveyance unit is output, wherein the double feeding-time process includes a process of resuming conveyance of the print media by controlling the conveyance unit and outputting the print media to the second output tray without forming an image on the print media using the image forming unit, and the normal-time process includes a process of resuming conveyance of the print media by controlling the conveyance unit and outputting the print media to the first output tray with forming an image on the print media using the image forming unit.

[4]

The image forming device described in any one of [1] to [3], in which the conveyance unit includes: a separation roller separating the print media picked up by the pickup roller one by one; a paper feed roller conveying the print media together with the separation roller; two resist rollers conveying the print media conveyed by the paper feed roller and the separation roller; a first detection unit configured to detect the print media located at a first position between the two resist rollers and the paper feed roller among positions on the conveyance path; and a second detection unit detecting the print media located at a second position located downstream of the first position in the conveyance path between the two resist rollers and the paper feed roller among positions on the conveyance path, and in which the control unit, after starting the conveyance of the print media, performs a second double feeding detecting process of detecting whether or not double feeding is occurring based on a detection result acquired by the first detection unit and a detection result acquired by the second detection unit and performs the first double feeding detecting process in a case in which it is judged that double feeding has not occurred in the second double feeding detecting process.

[5]

The image forming device described in any one of [1] to [4], in which the control unit performs the first double feeding detecting process before performing the write process.

[6]

The image forming device described in any one of [1] to [4], in which the control unit performs the first double feeding detecting process after performing the write process.

[7]

The image forming device described in [4], in which the control unit accepts an operation of designating whether or not the second double feeding detecting process is to be performed.

[8]

The image forming device described in [2], in which the control unit, in the first double feeding detecting process, accepts an operation of designating whether the double feeding-time process is to be performed in a case in which two or more pieces of the tag information have been read and whether the double feeding-time process is to be performed when the difference is the first value in a case in which two or more pieces of the tag information have been read.

[9]

A non-transitory computer readable medium on which a program executed by a computer of an image forming device, which includes: a housing unit configured to house print media to which wireless tags are attached; a conveyance unit configured to convey the print media from the housing unit one by one; and an image forming unit configured to form an image on the print media conveyed by the conveyance unit, is recorded, wherein the program causes the computer to: perform a write process of writing tag information into the wireless tag by controlling the conveyance unit and an antenna emitting radio waves to a conveyance path in which the print media is conveyed by the conveyance unit; and perform a first double feeding detecting process including a process, of performing to read the tag information from the wireless tag by controlling the antenna, then to perform one of a normal-time process according to the conveyance of the print media using the conveyance unit being normal and a double feeding-time process according to the conveyance of the print media using the conveyance unit being double feeding in accordance with whether or not two or more pieces of the tag information have been read.

While several embodiments have been described, such embodiments are presented as examples and are not intended to limit the scope of the invention. These embodiments can be performed in other various forms, and various omissions, substitutions, and other modifications can be made without departing from the spirit or scope of the invention. Accordingly, these embodiments and the modifications thereof, similar to a case of being included in the scope or the concept of the invention, are included in the invention described in the claims and the scope of equivalency thereof.

A program for realizing the function of an arbitrary constituent unit of the device described above (for example, the image forming device 1 or the like) may be recorded on a computer-readable recording medium, and a computer system may be caused to read and execute the program. A “computer system” described here includes an OS (Operating System) and hardware such as peripheral devices. A “computer-readable recording medium” represents a storage device including a portable medium such as a flexible disk, a magneto-optical disc, a ROM, or a CD (Compact Disk)-ROM, a hard disk built in a computer system, and the like. The “computer-readable recording medium” includes a device such as a volatile memory (RAM) disposed inside a computer system that serves as a server or a client that stores a program for a predetermined time in a case in which a program is transmitted through a network such as the Internet or a communication line such as a telephone line.

The program described above may be transmitted from a computer system storing this program in a storage device or the like to another computer system through a transmission medium or a transmission wave in a transmission medium. The “transmission medium” transmitting a program represents a medium having an information transmitting function such as a network (communication network) including the Internet and the like or a communication line (communication wire) including a telephone line. The program described above may be used for realizing a part of the functions described above. The program described above may be a program realizing the functions described above by being combined with a program recorded in the computer system in advance, a so-called a differential file (differential program).

What is claimed is:

1. An image forming device comprising:
a housing unit configured to house print media to which wireless tags are attached;
a conveyance unit configured to convey the print media from the housing unit one by one;
an image forming unit configured to form an image on the print media conveyed by the conveyance unit; and
a control unit configured to perform a write process of writing tag information into the wireless tag by controlling the conveyance unit and an antenna emitting radio waves to a conveyance path in which the print media is conveyed by the conveyance unit,
wherein the control unit is configured to perform a first double feeding detecting process including a process of performing to read the tag information from the wireless tag by controlling the antenna, then to perform one of a normal-time process according to the conveyance of the print media using the conveyance unit being normal and a double feeding-time process according to the conveyance of the print media using the conveyance unit being double feeding in accordance with whether or not two or more pieces of the tag information have been read.

2. The image forming device according to claim 1, wherein, in a case in which two or more pieces of the tag information have been read in the first double feeding detecting process, the control unit is configured to perform the double feeding-time process when a difference between received signal strengths of the two or more pieces of the tag information is a first value within a predetermined range, and to perform the normal-time process when the difference is a second value outside the predetermined range.

3. The image forming device according to claim 1, further comprising:
a first output tray to which the print media conveyed by the conveyance unit is output; and
a second output tray to which the print media conveyed by the conveyance unit is output,
wherein the double feeding-time process includes a process of resuming conveyance of the print media by controlling the conveyance unit and outputting the print media to the second output tray without forming an image on the print media using the image forming unit, and
the normal-time process includes a process of resuming conveyance of the print media by controlling the conveyance unit and outputting the print media to the first output tray with forming an image on the print media using the image forming unit.

4. The image forming device according to claim 2, further comprising:
a first output tray to which the print media conveyed by the conveyance unit is output; and
a second output tray to which the print media conveyed by the conveyance unit is output,
wherein the double feeding-time process includes a process of resuming conveyance of the print media by controlling the conveyance unit and outputting the print media to the second output tray without forming an image on the print media using the image forming unit, and
the normal-time process includes a process of resuming conveyance of the print media by controlling the conveyance unit and outputting the print media to the first output tray with forming an image on the print media using the image forming unit.

5. The image forming device according to claim 1,
wherein the conveyance unit includes:
a separation roller configured to separate the print media picked up by a pickup roller one by one;
a paper feed roller configured to convey the print media together with the separation roller;
two resist rollers configured to convey the print media conveyed by the paper feed roller and the separation roller;
a first detection unit configured to detect the print media located at a first position between the two resist rollers and the paper feed roller among positions on the conveyance path; and
a second detection unit configured to detect the print media located at a second position located downstream of the first position in the conveyance path between the two resist rollers and the paper feed roller among positions on the conveyance path, and
wherein the control unit, after starting the conveyance of the print media, is configured to perform a second double feeding detecting process of detecting whether or not double feeding is occurring based on a detection result acquired by the first detection unit and a detection result acquired by the second detection unit, and to perform the first double feeding detecting process in a case in which it is judged that double feeding has not occurred in the second double feeding detecting process.

6. The image forming device according to claim 2,
wherein the conveyance unit includes:
a separation roller configured to separate the print media picked up by a pickup roller one by one;
a paper feed roller configured to convey the print media together with the separation roller;
two resist rollers configured to convey the print media conveyed by the paper feed roller and the separation roller;
a first detection unit configured to detect the print media located at a first position between the two resist rollers and the paper feed roller among positions on the conveyance path; and
a second detection unit configured to detect the print media located at a second position located downstream of the first position in the conveyance path between the two resist rollers and the paper feed roller among positions on the conveyance path, and
wherein the control unit, after starting the conveyance of the print media, is configured to perform a second double feeding detecting process of detecting whether or not double feeding is occurring based on a detection result acquired by the first detection unit and a detection result acquired by the second detection unit, and to perform the first double feeding detecting process in a case in which it is judged that double feeding has not occurred in the second double feeding detecting process.

7. The image forming device according to claim 3,
wherein the conveyance unit includes:
a separation roller configured to separate the print media picked up by a pickup roller one by one;
a paper feed roller configured to convey the print media together with the separation roller;
two resist rollers configured to convey the print media conveyed by the paper feed roller and the separation roller;
a first detection unit configured to detect the print media located at a first position between the two resist rollers and the paper feed roller among positions on the conveyance path; and
a second detection unit configured to detect the print media located at a second position located downstream of the first position in the conveyance path between the two resist rollers and the paper feed roller among positions on the conveyance path, and
wherein the control unit, after starting the conveyance of the print media, is configured to perform a second double feeding detecting process of detecting whether or not double feeding is occurring based on a detection result acquired by the first detection unit and a detection result acquired by the second detection unit, and to perform the first double feeding detecting process in a case in which it is judged that double feeding has not occurred in the second double feeding detecting process.

8. The image forming device according to claim 4,
wherein the conveyance unit includes:
a separation roller configured to separate the print media picked up by a pickup roller one by one;
a paper feed roller configured to convey the print media together with the separation roller;
two resist rollers configured to convey the print media conveyed by the paper feed roller and the separation roller;
a first detection unit configured to detect the print media located at a first position between the two resist rollers and the paper feed roller among positions on the conveyance path; and
a second detection unit configured to detect the print media located at a second position located downstream of the first position in the conveyance path between the two resist rollers and the paper feed roller among positions on the conveyance path, and
wherein the control unit, after starting the conveyance of the print media, is configured to perform a second double feeding detecting process of detecting whether or not double feeding is occurring based on a detection result acquired by the first detection unit and a detection result acquired by the second detection unit, and to perform the first double feeding detecting process in a case in which it is judged that double feeding has not occurred in the second double feeding detecting process.

9. The image forming device according to claim 1, wherein the control unit is configured to perform the first double feeding detecting process before performing the write process.

10. The image forming device according to claim 2, wherein the control unit is configured to perform the first double feeding detecting process before performing the write process.

11. The image forming device according to claim 3, wherein the control unit is configured to perform the first double feeding detecting process before performing the write process.

12. The image forming device according to claim 4, wherein the control unit is configured to perform the first double feeding detecting process before performing the write process.

13. The image forming device according to claim 5, wherein the control unit is configured to perform the first double feeding detecting process before performing the write process.

14. The image forming device according to claim 6, wherein the control unit is configured to perform the first double feeding detecting process before performing the write process.

15. The image forming device according to claim 7, wherein the control unit is configured to perform the first double feeding detecting process before performing the write process.

16. The image forming device according to claim 8, wherein the control unit is configured to perform the first double feeding detecting process before performing the write process.

17. The image forming device according to claim 1, wherein the control unit is configured to perform the first double feeding detecting process after performing the write process.

18. The image forming device according to claim 5, wherein the control unit is configured to accept an operation of designating whether or not the second double feeding detecting process is to be performed.

19. The image forming device according to claim 2, wherein the control unit, in the first double feeding detecting process, is configured to accept an operation of designating whether the double feeding-time process is to be performed in a case in which two or more pieces of the tag information have been read and whether the double feeding-time process is to be performed when the difference is the first value in a case in which two or more pieces of the tag information have been read.

20. A non-transitory computer readable medium on which a program executed by a computer of an image forming device, which includes: a housing unit configured to house print media to which wireless tags are attached; a conveyance unit configured to convey the print media from the housing unit one by one; and an image forming unit configured to form an image on the print media conveyed by the conveyance unit, is recorded,
wherein the program causes the computer to: perform a write process of writing tag information into the wireless tag by controlling the conveyance unit and an antenna emitting radio waves to a conveyance path in which the print media is conveyed by the conveyance unit; and perform a first double feeding detecting process including a process of performing to read the tag information from the wireless tag by controlling the antenna, then to perform one of a normal-time process according to the conveyance of the print media using the conveyance unit being normal and a double feeding-time process according to the conveyance of the print media using the conveyance unit being double feeding in accordance with whether or not two or more pieces of the tag information have been read.
